(19) United States
(12) Patent Application Publication
(10) Pub. No.: US 2021/0286150 A1
(43) Pub. Date: Sep. 16, 2021

(54) OPTICAL SYSTEM HAVING SECONDARY MIRROR FOCUSING MECHANISM

(71) Applicant: National Applied Research Laboratories, Taipei (TW)

(72) Inventors: Wei-Chuan Wu, Hsinchu (TW); Jen-Chueh Kuo, Hsinchu (TW)

(73) Assignee: National Applied Research Laboratories, Taipei (TW)

(21) Appl. No.: 17/198,555

(22) Filed: Mar. 11, 2021

(30) Foreign Application Priority Data
Mar. 12, 2020 (TW) 109108229

(51) Int. Cl. G02B 7/183; G02B 17/06

(52) U.S. Cl. CPC G02B 7/183; G02B 17/06

(57) ABSTRACT

An optical system having a secondary mirror refocusing mechanism includes a primary mirror; a secondary mirror arranged corresponding to the primary mirror, and the secondary mirror is smaller than the primary mirror; a mirror base for receiving the secondary mirror; a beam having a first end and a second end disposed opposite to each other; and an actuation mechanism including a thermal deformation structure and a heating device, the heating device provides thermal energy to the thermal deformation structure such that the thermal deformation structure generates a deformation; wherein, the first end of the beam is fixed to the mirror base, the second end of the beam is fixed to the actuation mechanism, and the beam and the actuation mechanism are deformed correspondingly. With the above structure, the secondary mirror can be refocused to ensure the imaging quality of the optical system.

### BACKGROUND OF THE INVENTION

### 1. Field of the Invention

The present invention relates to an optical system, and more particularly to an optical system having a secondary mirror focusing mechanism.

### 2. Description of Related Art

In the field of telescopes, the optical imaging devices, such as the refracting telescope or the reflecting telescope, can help an observer or an image capturing device to obtain an image of a distant object. Wherein, for the astronomical observation, the reflective telescope is usually adopted. With reference to FIG. 1, the optical system usually includes a primary mirror 100a and a secondary mirror 200a. The secondary mirror 200a is disposed corresponding to the primary mirror 100a, and the secondary mirror 200a is smaller than the primary mirror 100a. The light emitted from the image of the object to be observed is reflected by the primary mirror 100a to the secondary mirror 200a. After being focused, and the light is further emitted to the observer or the image capturing device.

As discussed above, the relative position and the relative tilting situation between the primary mirror 100a and the secondary mirror 200a will greatly affect the focus situation and the following image quality. Therefore, how to adjust the relative position in order to focus well becomes an important part of optical imaging device. As shown in FIG. 1, for the secondary mirror 200a, there are three adjustable degree of freedom, respectively, a relative distance (Tz) between the primary mirror 100a and the secondary mirror 200a on the system Z axis, a tilting angle (Ry) between the secondary mirror 200a and the system Y axis, and a tilting angle (Rx) between the secondary mirror 200a and the system X axis.

In the manufacturing process of a telescope, the above Tz, Rx, Ry are well adjusted and tested. For a telescope launched to the space, in the launch process and functions of thermal expansion, thermal contraction and external force in the space, the focus ability of the telescope is lost. Therefore, how to refocusing for the secondary mirror 200a in order to ensure the imaging quality become a problem required to be solved.

### SUMMARY OF THE INVENTION

In order to solve the refocusing problem of the current optical system, the present invention provides an optical system having a secondary mirror focusing mechanism, and the optical system comprises a primary mirror; a secondary mirror arranged corresponding to the primary mirror, and the secondary mirror is smaller than the primary mirror; a mirror base for receiving the secondary mirror; at least one beam having a first end and a second end which are disposed oppositely; and an actuation mechanism, wherein the actuation mechanism includes a thermal deformation structure and a heating device, the heating device provides a heat to the thermal deformation structure such that the thermal deformation structure can generate a deformation; wherein the first end of the beam is fixed to the mirror base, the second end of the beam is fixed to the actuation mechanism, and the beam is deformed correspondingly with respect to the thermal deformation structure of the actuation mechanism.

Wherein the actuation mechanism further includes a heat isolation material and a supporting column, the heat isolation material surrounds the thermal deformation structure, the thermal deformation structure and the heat isolation material are disposed at two terminals of the supporting column, and the second end of the beam is fixed to the supporting column.

Wherein the heating device is fixed to the thermal deformation structure, and electrically connected to a control circuit.

Wherein the shape of the thermal deformation structure is as “H”.

Wherein the number of the at least one beam is three, and the three beams are fixed evenly at an outer edge of the mirror base, and mutually located with 120 degrees.

In the optical system, through the heating device to provide the heat to the thermal deformation structure in order to generate a deformation and through the beam to deform correspondingly, the position of the secondary mirror and the focus situation can be adjusted in order to ensure the image quality of the optical system.

### BRIEF DESCRIPTION OF THE DRAWINGS

FIG. 1 is a schematic diagram of the optical system of the refracting telescope of the prior art;

FIG. 2 is a schematic diagram of an optical system having a secondary mirror focusing mechanism of the present invention;

FIG. 3 is an enlarged diagram of portion “A” of the optical system having a secondary mirror focusing mechanism of the present invention;

FIG. 4(a) is a schematic diagram of the optical system having a secondary mirror focusing mechanism before heating;

FIG. 4(b) is a schematic diagram of the optical system having a secondary mirror focusing mechanism after heating; and

FIG. 4(c) is a schematic diagram of the optical system having a secondary mirror focusing mechanism after heating.

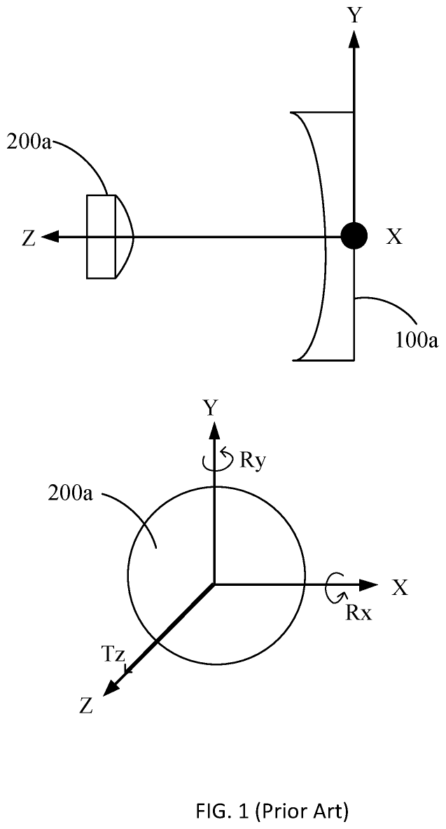

### DETAILED DESCRIPTION OF THE PREFERRED EMBODIMENT

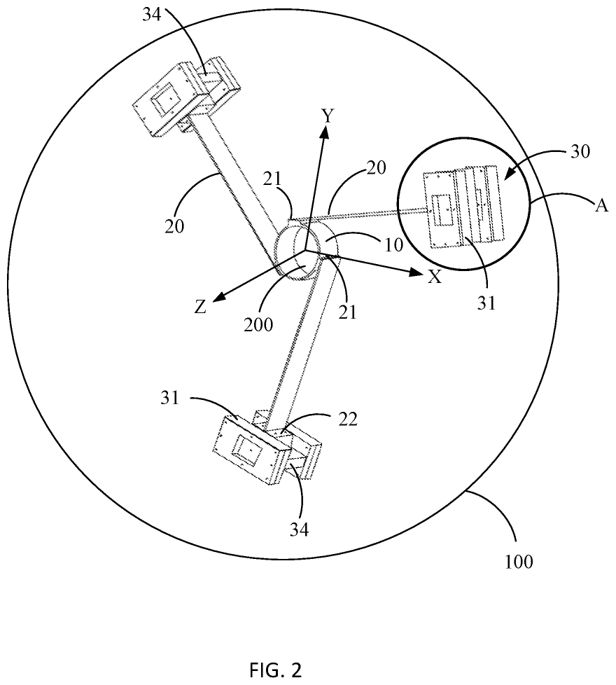

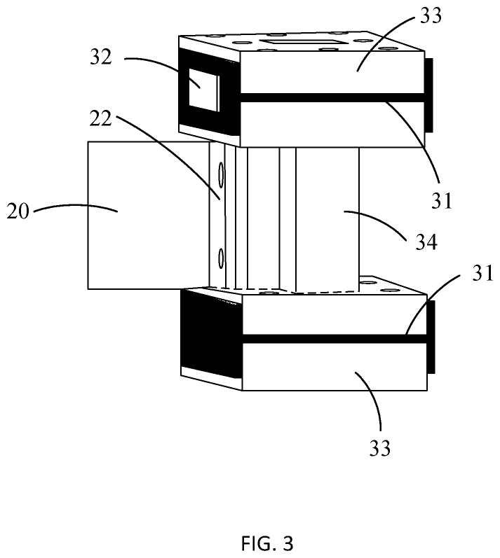

With reference to FIG. 2 and FIG. 3, FIG. 2 is a schematic diagram of an optical system having a secondary mirror focusing mechanism of the present invention, and FIG. 3 is an enlarged diagram of portion “A” of the optical system having a secondary mirror focusing mechanism of the present invention. The optical system having a secondary mirror focusing mechanism of the present invention includes a primary mirror 100; a secondary mirror 200 arranged corresponding to the primary mirror 100; a mirror base 10, which is used for receiving the secondary mirror 200; a beam 20, and an actuation mechanism 30. The mirror base 10 is connected and contacted with the secondary mirror 200. In the present invention, the mirror base 10 surrounds and receives the secondary mirror 200. The beam 20 has a first end 21 and a second end 22. The first end 21 is fixed to the mirror base 10, the second end 22 is connected and fixed to the actuation mechanism 30. The actuation mechanism 30 includes a thermal deformation structure 31 and a heating device 32. The heating device 32 provides thermal energy to the thermal deformation structure 31 such that the thermal deformation structure 31 can generate a deformation. The beam 20 is fixed to the thermal deformation structure 31, and is deformed correspondingly with the thermal deformation structure 31 to generate a deformation in order to drive the mirror base 10 and the secondary mirror 200 to generate a tilt angle.

There are many connection ways for the second end 22 of the beam 20 and the actuation mechanism 30. At the same time, there are also many connection ways for the beam 20 and the thermal deformation structure 31. The following provide some embodiments; however, the present invention is not limited. With reference to FIG. 3, the shape of the thermal deformation structure 31 is as “H”. The actuation mechanism 30 further includes a heat isolation material 33 and a supporting column 34. The heat isolation material 33 surrounds the thermal deformation structure 31. Accordingly, the heat provided from the heating device 32 to the thermal deformation structure 31 will not dissipate quickly such that the deformation degree of the deformation structure 31 is well controlled. The thermal deformation structure 31 and the heat isolation material 33 are disposed at two terminals of the heat isolation material 34. The second end 22 of the beam 20 is fixed at the supporting column 34. The following content will describe the interaction between the beam 20 and the thermal deformation structure 31, and driving the mirror base 10 and the secondary mirror 200 to generate a tilting angle.

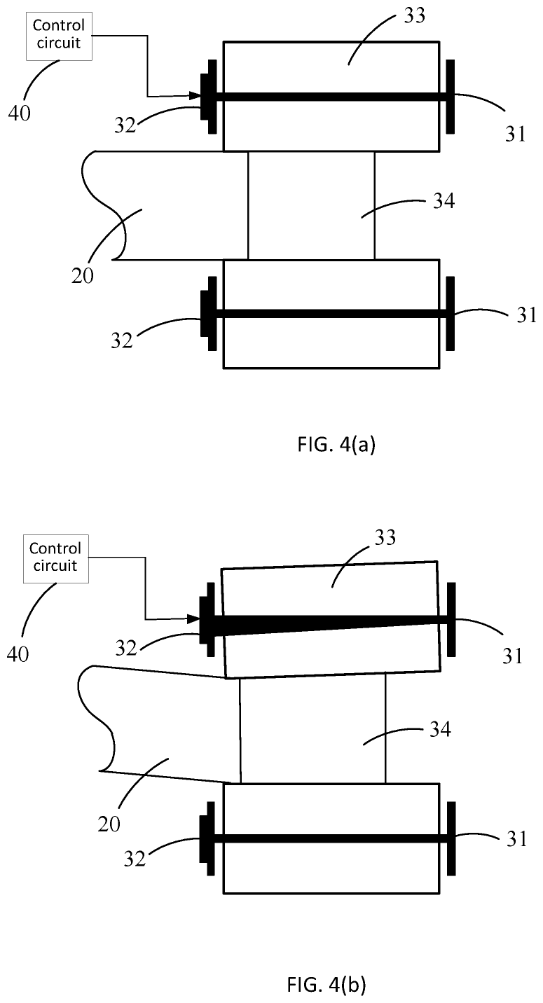

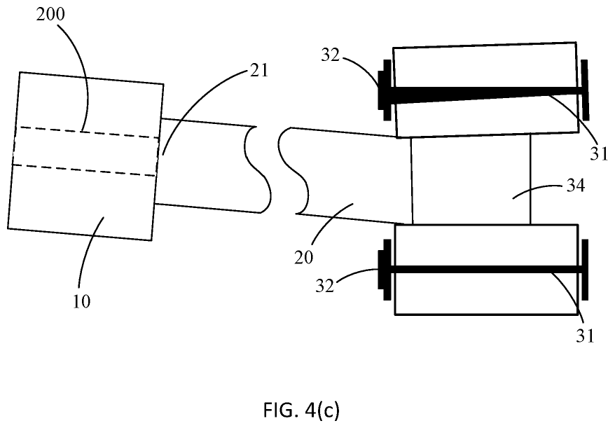

With reference to FIG. 4(a), FIG. 4(b) and FIG. 4(c), wherein FIG. 4(a) is a schematic diagram of the optical system having a secondary mirror focusing mechanism before heating, FIG. 4(b) and FIG. 4(c) are schematic diagrams of the optical system having a secondary mirror focusing mechanism after heating. First of all, as shown in FIG. 4(b), the heating device 32 heats the thermal deformation structure 31 so that the thermal deformation structure 31 is deformed such that the heat isolation material 33 which surrounds the thermal deformation structure 31 is also deformed. Then, the beam 20 fixed to the supporting column 34 is deformed correspondingly. With reference to FIG. 4(c) the deformation of the beam 20 can drive the mirror base 10 and the secondary mirror 200 to generate a tilting angle in order to adjust the focal length of the optical system. Accordingly, through the above way, the secondary mirror 200 can be refocused in order to ensure the image quality of the optical system. Besides, the heating device 32 can be a heating film. The heating device 32 is fixed to the thermal deformation structure 31 and electrically connected to a control circuit 40 in order to precisely control the heat providing to the heating device 32. For a refracting telescope launched to the outer space, the control circuit 40 can be controlled through a control signal emitted from the ground in order to adjust the focus situation remotely.

With reference to FIG. 2, preferably, the number of the beam 20 is three, and the three beams 20 are fixed evenly at an outer edge of the mirror base 10. That is, the first ends 21 are mutually located with 120 degrees. Accordingly, a stable supporting is provided, and the tilting angle of the secondary mirror 200 can be adjusted flexibly.

As described above, in the optical system, through the heating device 32 to provide the heat to the thermal deformation structure 31 in order to generate a deformation and through the beam 20 to deform correspondingly, the position of the secondary mirror 200 and the focus situation can be adjusted in order to ensure the image quality of the optical system.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. An optical system having a secondary mirror focusing mechanism, comprising:
a primary mirror;
a secondary mirror arranged corresponding to the primary mirror, and the secondary mirror is smaller than the primary mirror;
a mirror base for receiving the secondary mirror;
at least one beam having a first end and a second end which are disposed oppositely; and
an actuation mechanism, wherein the actuation mechanism includes a thermal deformation structure and a heating device, the heating device provides a heat to the thermal deformation structure such that the thermal deformation structure can generate a deformation;
wherein the first end of the beam is fixed to the mirror base, the second end of the beam is fixed to the actuation mechanism, and the beam is deformed correspondingly with respect to the thermal deformation structure of the actuation mechanism.

2. The optical system having a secondary mirror focusing mechanism according to claim 1, wherein the actuation mechanism further includes a heat isolation material and a supporting column, the heat isolation material surrounds the thermal deformation structure, the thermal deformation structure and the heat isolation material are disposed at two terminals of the supporting column, and the second end of the beam is fixed to the supporting column.

3. The optical system having a secondary mirror focusing mechanism according to claim 2, wherein the heating device is fixed to the thermal deformation structure, and electrically connected to a control circuit.

4. The optical system having a secondary mirror focusing mechanism according to claim 3, wherein the shape of the thermal deformation structure is as “H”.

5. The optical system having a secondary mirror focusing mechanism according to claim 4, wherein the number of the at least one beam is three, and the three beams are fixed evenly at an outer edge of the mirror base, and mutually located with 120 degrees.
